(19) United States
(12) Patent Application Publication
(10) Pub. No.: US 2018/0005756 A1
(43) Pub. Date: Jan. 4, 2018

(54) PLATE CUT LINEAR MOTOR COIL FOR ELEVATOR SYSTEM

(71) Applicant: OTIS ELEVATOR COMPANY, Farmington, CT (US)

(72) Inventor: Richard N. Fargo, Plainville, CT (US)

(21) Appl. No.: 15/545,529

(22) PCT Filed: Jan. 19, 2016
(86) PCT No.: PCT/US2016/013873

§ 371 Date: Jul. 21, 2017

Related U.S. Application Data
(60) Provisional application No. 62/106,323, filed on Jan. 22, 2015.

(51) Int. Cl. H01F 41/12; H01F 41/066; H02K 15/04; H01F 27/28

(52) U.S. Cl. CPC H01F 41/125; H01F 41/066; H02K 15/0407; H01F 27/2852

(57) ABSTRACT

An assembly and method of manufacturing the coil assembly is provided. The method includes acquiring a sheet of a conductive metal and producing a plurality of coils from the sheet of conductive metal. Further, the method includes layering at least two of the plurality of coils with an insulation layer there between to construct the coil assembly and electrically coupling the at least two of the plurality of coils within the coil assembly.

### FIELD OF INVENTION

The subject matter disclosed herein relates generally to the field of elevators, and more particularly to a multicar, ropeless elevator system.

### BACKGROUND

Ropeless elevator systems, also referred to as self-propelled elevator systems, are useful in certain applications (e.g., high rise buildings) where the mass of the ropes for a roped system is prohibitive and there is a desire for multiple elevator cars to travel in a single lane. There exist ropeless elevator systems in which a first lane is designated for upward traveling elevator cars and a second lane is designated for downward traveling elevator cars. A transfer station at each end of the hoistway is used to move cars horizontally between the first lane and second lane.

### BRIEF DESCRIPTION OF THE INVENTION

According to one embodiment of the invention, a method of manufacturing a coil assembly comprises acquiring a sheet of a conductive metal; producing a plurality of coils from the sheet of conductive metal; layering at least two of the plurality of coils with an insulation layer there between to construct the coil assembly; and electrically coupling the at least two of the plurality of coils within the coil assembly.

In another embodiment or in accordance with the above embodiment, the method can further comprise performing high volume manufacturing process to make a spiral cut for each coil of the plurality of coils from the sheet of conductive metal.

In another embodiment or in accordance with any of the above embodiments, the method can further comprise potting the coil assembly.

In another embodiment or in accordance with any of the above embodiments, the electrically coupling of the at least two of the plurality of coils can include inserting a conductive connection through designated contacts of the at least two of the plurality of coils.

In another embodiment or in accordance with any of the above embodiments, the at least two of the plurality of coils can be a first and second coil, the first coil can be oriented in a first spiral direction within the coil assembly, and the second coil can be oriented in a second spiral direction that is opposite the first spiral direction within the coil assembly.

In another embodiment or in accordance with any of the above embodiments, the coil assembly can be included in a linear motor system of an elevator system.

In another embodiment or in accordance with any of the above embodiments, the coil assembly can be mounted on a ferromagnetic support.

In another embodiment or in accordance with any of the above embodiments, the coil assembly can be one of a plurality of assemblies, each coil assembly being associated with each phase of a drive signal, wherein the plurality of coils of each coil assembly is connected in series enabling an applied current to flow in opposite directions with respect to any adjacent coil assemblies of the plurality of assemblies.

In another embodiment or in accordance with any of the above embodiments, the method can further comprise forming a coating of insulation material on each of the plurality of coils, the forming of the coating of insulation material on each of the plurality of coils includes forming the insulation material directly onto each coil.

In another embodiment or in accordance with any of the above embodiments, the method can further comprise extracting the coils from an aluminum sheet; and performing an anodizing process to create an insulating layer.

In another embodiment or in accordance with any of the above embodiments, the insulation layer can be a sheet of insulating material applied between the plurality of coils.

According to one embodiment of the invention, a coil assembly comprises at least two coils of a plurality of coils, each of the plurality of coils being extracted from a sheet of conductive material; and a first insulating layer configured between the two coils of the plurality of coils.

In another embodiment or in accordance with the above embodiment, each of the plurality of coils can include a metal band with a first thickness, a first width that width, and formed with at least eight turns to produce a structure of each of the plurality of coils.

In another embodiment or in accordance with any of the above embodiments, the at least two coils can be rounded at each turn during stamping or cutting.

In another embodiment or in accordance with any of the above embodiments, the at least two coils can be cornered at each turn during stamping or cutting.

In another embodiment or in accordance with any of the above embodiments, the coil assembly can be included in a linear motor system of an elevator system.

In another embodiment or in accordance with any of the above embodiments, the coil assembly can be mounted on a ferromagnetic support.

In another embodiment or in accordance with any of the above embodiments, the coil assembly can be one of a plurality of assemblies, each coil assembly being associated with each phase of a drive signal, wherein the plurality of coils of each coil assembly is connected in series enabling an applied current to flow in opposite directions with respect to any adjacent coil assemblies of the plurality of assemblies.

In another embodiment or in accordance with any of the above embodiments, each of the plurality of coils can be coated with a first insulation coating.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 depicts a multicar elevator system in an exemplary embodiment;

FIG. 2 illustrates a process flow according to an embodiment of the invention;

FIG. 3A illustrates a pair of coils according to an embodiment of the invention;

FIG. 3B illustrates a cross section of a pair of coils according to an embodiment of the invention;

FIG. 4A illustrates another pair of coils according to an embodiment of the invention;

FIG. 4B illustrates another cross section of a pair of coils according to an embodiment of the invention;

FIG. 5 illustrates a profile of coil assembly according to an embodiment of the invention;

FIG. 6 depicts a drive and a section of the primary portion and the secondary portion of a linear propulsion system in an exemplary embodiment.

### DETAILED DESCRIPTION

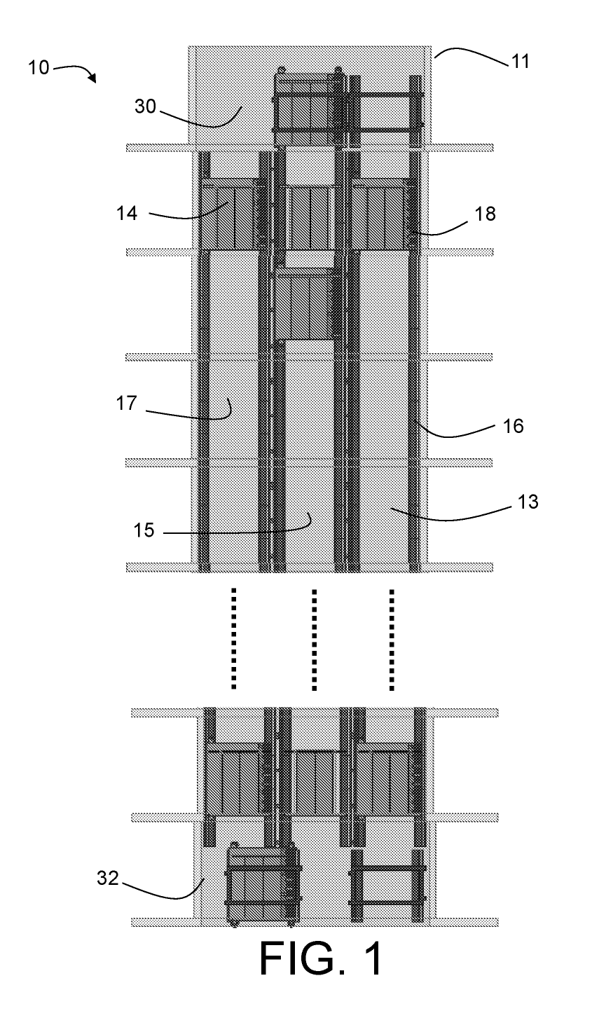

FIG. 1 depicts an multicar, ropeless elevator system 10 in an exemplary embodiment. Elevator system 10 includes a hoistway 11 having a plurality of lanes 13, 15 and 17. While three lanes are shown in FIG. 1, it is understood that embodiments may be used with multicar ropeless elevator systems that have any number of lanes. In each lane 13, 15, 17, cars 14 travel in one direction, i.e., up or down. For example, in FIG. 1 cars 14 in lanes 13 and 15 travel up and cars 14 in lane 17 travel down. One or more cars 14 may travel in a single lane 13, 15, and 17.

Above the top floor is an upper transfer station 30 to impart horizontal motion to elevator cars 14 to move elevator cars 14 between lanes 13, 15 and 17. It is understood that upper transfer station 30 may be located at the top floor, rather than above the top floor. Below the first floor is a lower transfer station 32 to impart horizontal motion to elevator cars 14 to move elevator cars 14 between lanes 13, 15 and 17. It is understood that lower transfer station 32 may be located at the first floor, rather than below the first floor. Although not shown in FIG. 1, one or more intermediate transfer stations may be used between the first floor and the top floor. Intermediate transfer stations are similar to the upper transfer station 30 and lower transfer station 32.

Cars 14 are propelled using a linear motor system (a.k.a. a linear propulsion system) having a primary, fixed portion 16 and a secondary, moving portion 18. The primary portion 16 includes windings or coils mounted at one or both sides of the lanes 13, 15 and 17. Secondary portion 18 includes permanent magnets mounted to one or both sides of cars 14. Primary portion 16 is supplied with drive signals to control movement of cars 14 in their respective lanes.

The primary portions 16 of linear motor system of the system 10 can employ coils of wire, without a ferromagnetic core. These wires require two layers of insulation, which must be applied before winding, and in turn must resist damage during the winding process. In addition, as the system 10 requires speed increases, each coil must respectively increase a thickness of the wires and decrease a number of required turns, both of which significantly increase difficultly of accurately bend the wires while adding more strain to the insulation. In general, this winding and layering method of making coils is expensive, as each coil adds a significant portion to the cost of the system 10. In view of the above, embodiments of the present invention set forth a new coil, coil assembly, and manufacturing process thereof.

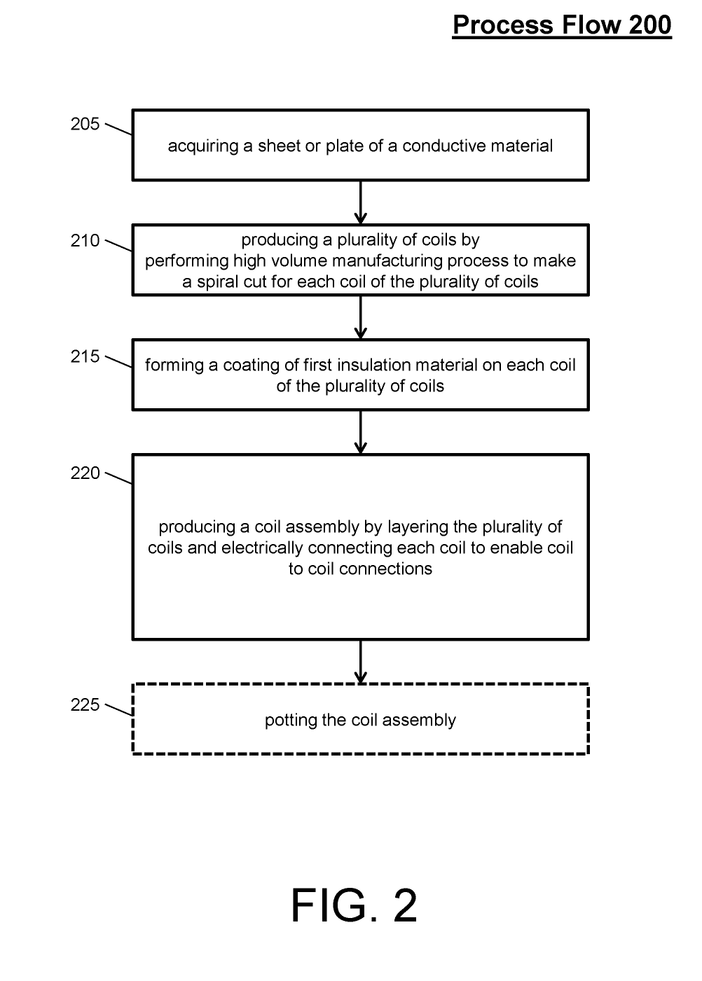

In one embodiment of the invention, FIG. 2 illustrates a process flow 200 that provides significant advantages over traditional winding by using sheet metal windings. For instance, traditional winding generally includes insulating a wire with insulating material capable of withstanding significant deformation during winding, a winding operation itself, and removal of insulation for terminating the wires. The insulating material capable of withstanding significant deformation is a design constraint for traditional winding. Further, the wires used for traditional winding are soft to enable the winding operation, and therefore have limited structural integrity. The limited structural integrity requires more support for the wires. In contrast, the sheet metal windings of the process flow 200 are produced to have a wide shape, which is strong in the direction of loading in a coreless linear motor. Further, the stamped coils can be fully insulated before punching connection holes with any suitable insulating material, as a punching process both creates a hole, and provides an uninsulated surface inside the hole for electrical contact.

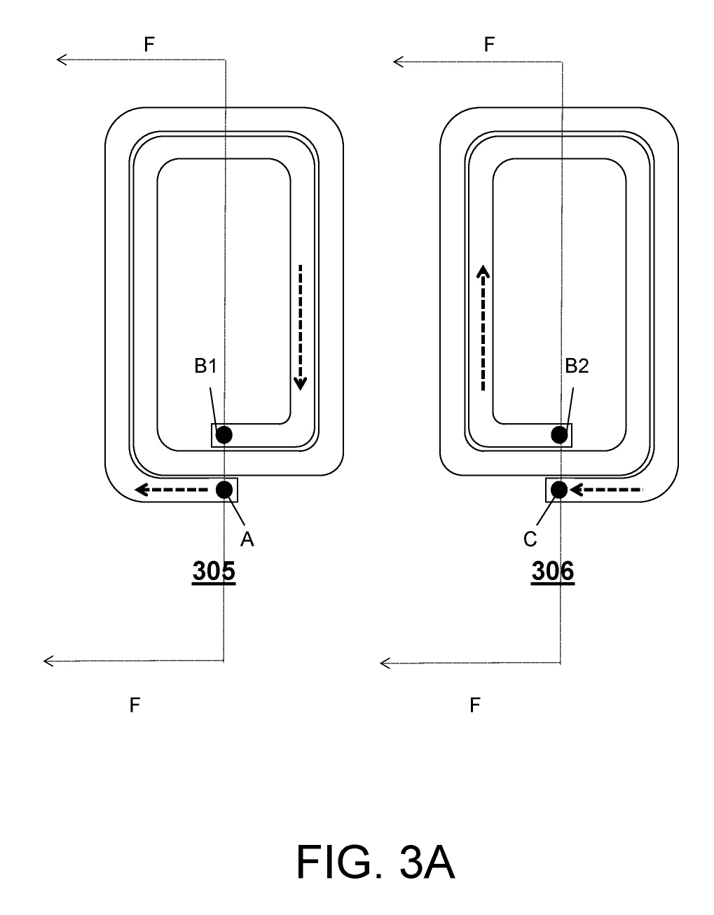

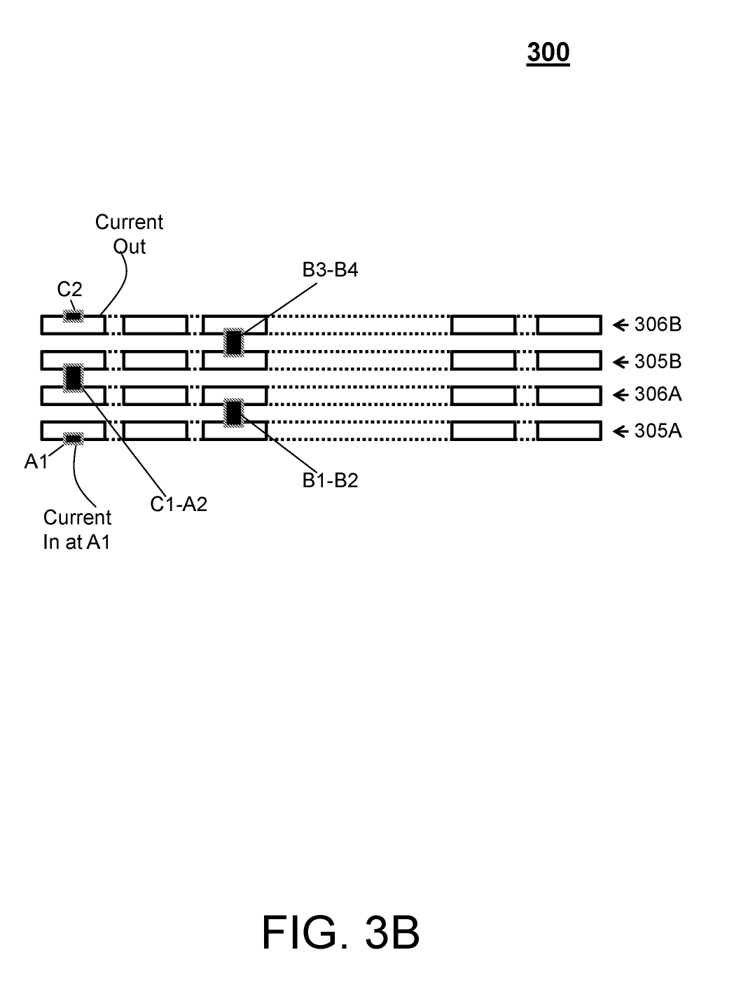

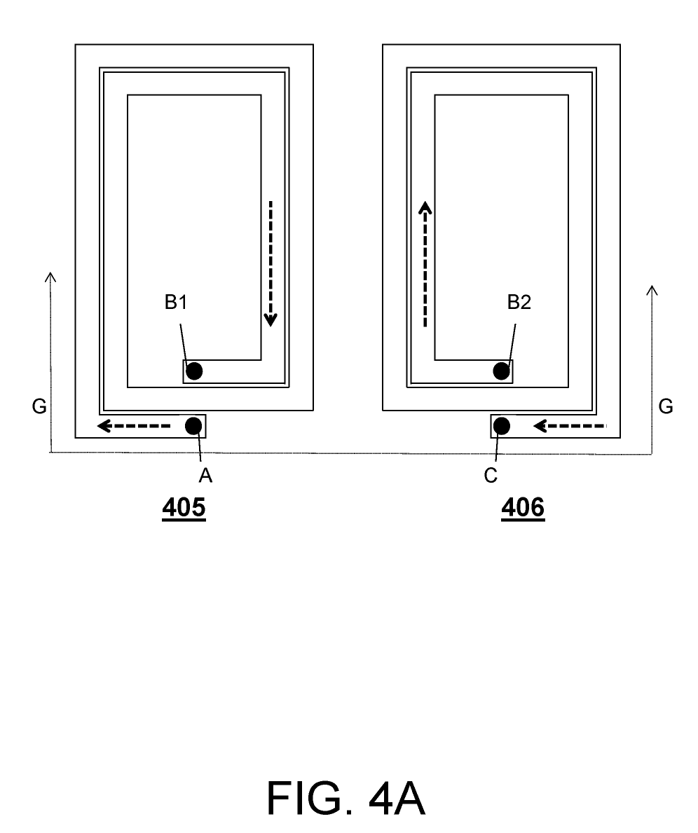

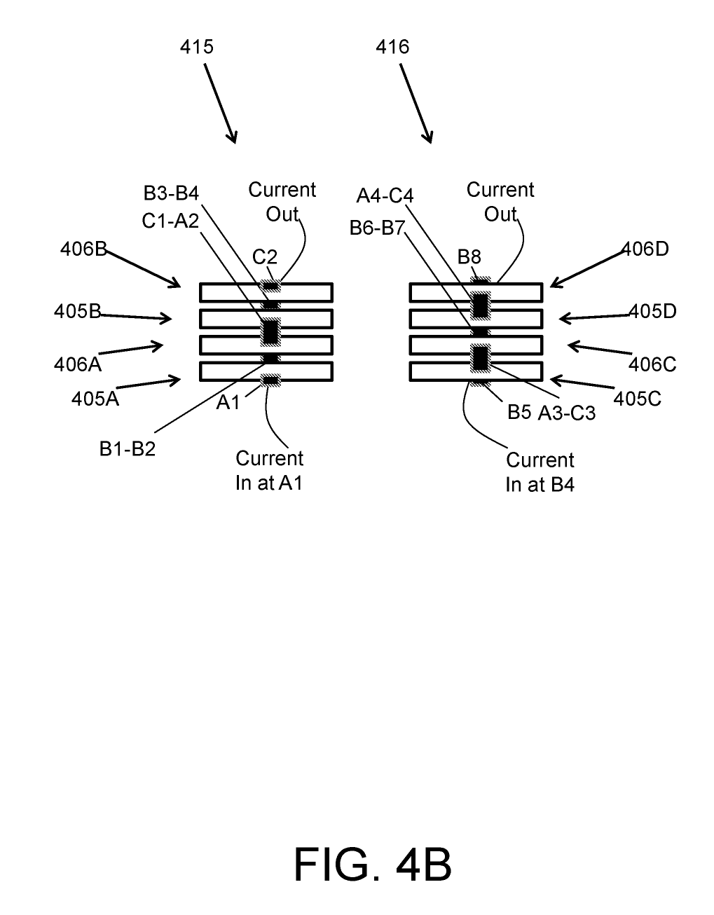

The process flow 200 starts at block 205 where a sheet or plate of a conductive material, such as aluminum, copper, alloy thereof, or the like, is acquired (e.g., the thickness of the sheet metal can be along the range of 0.5 mm to 4 mm). Also, At block 210, a plurality of coils is extracted from a sheet or plate of a conductive material (e.g., embodiments of the plurality of coils are further described below with respect to FIGS. 3A, 4A). For instance, the plurality of coils is produced by performing high volume manufacturing process that makes a spiral cut for each coil of the plurality of coils into the sheet or plate of the conductive material. Examples of the high volume manufacturing process include stamping, laser cutting, water jet cutting, shearing, etc. Each of the plurality of coils includes characteristics of a plurality of turns, a coil thickness, a coil surface area, a coil cross sectional area, a turn shape, a band width, a band spacing, etc. Each of these characteristics can vary to directly produce and/or affect electrical properties desired for the linear motor system of the system 10.

The process continues to block 215 where a first coating of insulation material is formed over each coil of the plurality of coils. For example, in the case of aluminum coils, the first coating of insulation material can be formed over each coil through anodizing or an application of a varnish. Note that the coils can be varnished without holes for making electrical connections, such that when holes are punched after applying the insulating material, a conductive surface is exposed inside the hole for making the electrical connection.

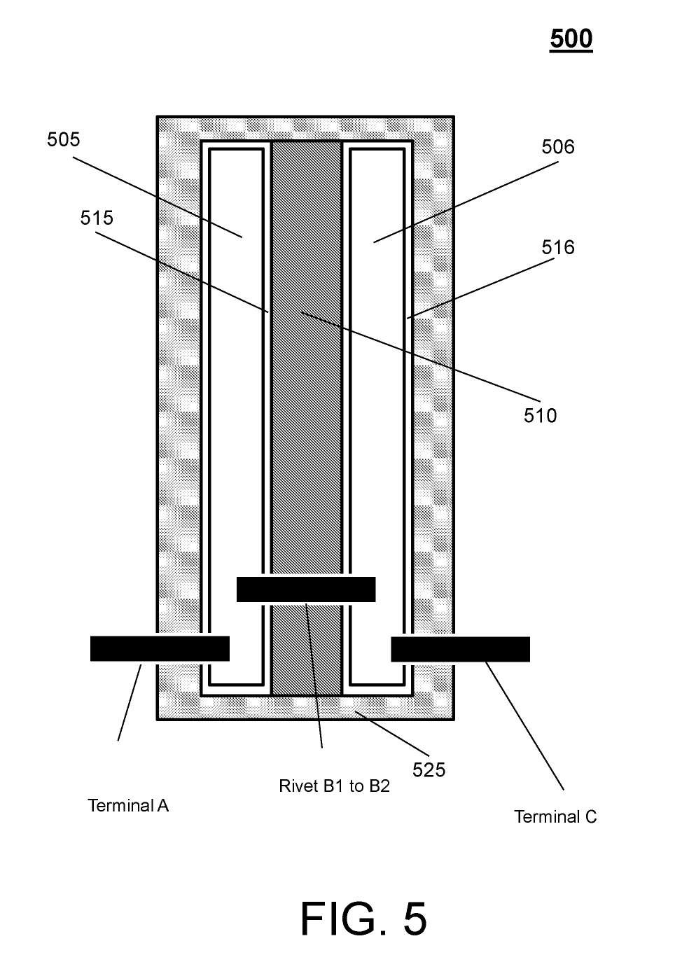

Then, at block 220, a coil assembly is produced by stacking the plurality of coils in an alternating fashion (e.g., embodiments of coil assemblies are further described below with respect to FIGS. 3B, 4B). In one embodiment, the plurality of coils can be stacked in combination with a second insulation material (e.g., as further described below with respect to FIG. 5), which may be the same or different as the first material. In another embodiment, the second insulation material (and/or the first coating) may be injection molded into a form which fills the spiral grooves of the coils. Note that the coil assembly may not include the second insulation material if the coils are individually insulated by the first coating of insulation material. Alternatively, the coil assembly may not include the first coating of insulation material and be left bare if the coils are insulated by the second insulation material. Further, the coil assembly can include both the first coating of insulation material and the second insulation material.

Further, each coil is electrically connected. For example, rivets can be used to make coil to coil connections between adjacent layers. At block 225, a final coil assembly can be produced by potting the coil assembly of block 220. Note that block 225 is outlined in a dashed-line to illustrate the potting is optional when if additional insulation is required. Note that once the final coil assembly is potted, it is basically rigid and capable of carrying loads.

Embodiments of the plurality of coils and coil assemblies will now be described with reference to FIGS. 3A-5. FIG. 3A illustrates a pair of coils (e.g., coils 305, 306) according to an embodiment of the invention. The coil 305 shows a clockwise profile from contact A to contact B1, while the coil 306 shows a counter clockwise profile contact B2 to contact C. The contacts A, B1, B2, C are electrical connecting points that enable a coil to electrically couple to another coil and/or an electrical lead external to that coil. When conducting a current, a flow of electricity can follow a conductive path illustrated by the dashed arrows from contact A in a spiral fashion to contact B1, which is connected to contact B2. Then the flow of electricity can follow a conductive path illustrated by the dashed arrows from contact B2 in a spiral fashion to contact C. When stamped, both coils can be cut from the same sheet of conductive material and oriented the same way on that sheet of conductive material; however, coils 305, 306 are illustrated as clockwise and counterclockwise to depict how the coils 305, 306 may be stacked in a coil assembly (as further discussed below).

FIG. 3B illustrates an assembly of stacked coils from the viewpoint of section F-F from FIG. 3A. That is, FIG. 3B depicts a coil assembly 300 showing a stack of alternating coils 305A, 306A, 305B, 306B. As shown in FIG. 3B, a current flows into the coil assembly 300 at Al (e.g., Current In) of a first coil 305A and flows out of B1 of the first coil 305B into B2 of a second coil 306A. Then the current flows out of C1 of the second coil 306A and into A2 of a third coil 305B. Next, the current flows out of B3 of the third coil 305B and into B4 of a fourth coil 306B. Then, the current flows out of C2 of the fourth coil 306B (e.g., Current Out). Note that this can continue repeating for a coil assembly of any number of coils, as more layers can be added and connected in the same alternating pattern.

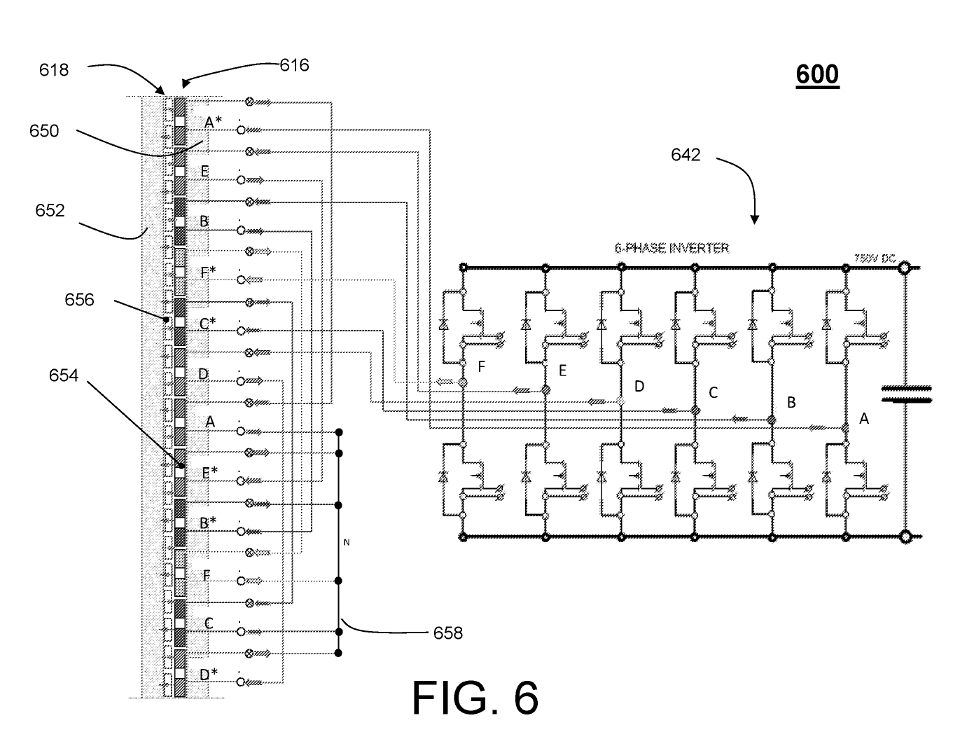

FIG. 4A illustrates another pair of coils (e.g., coils 405, 406) according to an embodiment of the invention. The coil 405 shows a clockwise profile from contact A to contact B 1, while the coil 406 shows a counter clockwise profile contact B2 to contact C. Further, FIG. 4B illustrates another two assemblies of stacked coils 415, 416 from a viewpoint G-G from FIG. 4A. That is, FIG. 4B depicts a coil assembly 415 showing a stack of alternating coils 405A, 406A, 405B, 406B and a coil assembly 416 showing a stack of alternating coils 405C, 406C, 405D, 406D, each with alternating connections marked by black rectangles. In general, the coil assemblies 415, 416 are adjacent in a linear propulsion system (as shown in FIG. 4B and further describe below with respect to FIG. 6). In some embodiment, a coil assembly 415 can be oriented so that a currently flow is opposite in direction to a current flow of coil assembly 416. Further, there can also be a 120 degree phase angle between adjacent phases of the coil assemblies 415, 416. In turn, depending on the electrical angle, the current may be going the same or opposite directions with different magnitudes. Thus, the currents in adjacent phases are related.

As shown in FIG. 4B, a current flows into the coil assembly 415 at A1 (e.g., Current In) of a first coil 405A and flows out of B1 of the first coil 405A into B2 of a second coil 406A. Then the current flows out of C1 of the second coil 406A and into A2 of a third coil 405B. Next, the current flows out of B3 of the third coil 405B and into B4 of a fourth coil 406B. Then, the current flows out of C2 of the fourth coil 406B (e.g., Current Out). Note that this can continue repeating for a coil assembly of any number of coils. Also, as shown in FIG. 4B, a current flows into the coil assembly 416 at B5 (e.g., Current In) of a fifth coil 405C and flows out of A3 of the fifth coil 405C into C3 of a sixth coil 406C. Then the current flows out of B6 of the sixth coil 406C and into B7 of a seventh coil 405D. Next, the current flows out of A4 of the seventh coil 405D and into C4 of an eighth coil 406D. Then, the current flows out of B8 of the eighth coil 406D (e.g., Current Out).

Each embodiment of FIGS. 3A, 4B has a cross sectional area that generally depends on a width of each band multiplied by a thickness, along with a shape of each turn (note that a surface area of a coil depends on the width of each band multiplied by length and is related to heat transfer of the coil). The cross sectional area may further be increased in accordance with reducing a space between each band and/or increasing a size of each turn. For example, the shape of each coil 305, 306 can be a rounded edge for each of the eight turns that can extend a predetermined radius, which can be beyond a corner of a wound coil, due to the flexibility of stamping. Further, the shape of each coil 405, 406 is cornered for each of the eight turns that can extend beyond any rounded edge of the coils 305, 306. Thus, each stamped coil 305, 306, 405, 406 can achieve a maximum cross sectional area, e.g., without affecting the integrity of the metal at the turns. That is, because during winding an operation of bending metal reduces a physical integrity of the coil at each turn, stamping each coil enables a manufacture of precise turns without affecting the integrity of the metal at the precise turns.

FIG. 5 illustrates a profile of a coil assembly 500 according to another embodiment of the invention. The coil assembly 500 includes a first coil 505, a second coil 506, a first insulating layer, a first insulating coating 515, a second insulating coating 516, and a second insulating layer 525. The first coil 505 is oriented in a first spiral direction (e.g., clockwise as shown in FIG. 3, coil 305) and is stacked with a second coil 506 that is oriented in a second spiral direction (e.g., counter clockwise as shown in FIG. 3, coil 306) with an insulating sheet 510 there between. When conducting a current, a flow of electricity can follow a conductive path from contact A in a spiral fashion through the first coil 505 to contact B, and then from contact B in an opposite spiral fashion through the second coil 506 to contact C.

While two coils 505, 506 are shown in FIG. 5, any number of coils can be utilized in the coil assembly 500. In this way, the coil assembly 500 can increase a number of turns for any given coil based on a number of layered or stacked coils (e.g., for an unlimited number of layers and turns). In addition, the characteristics of each coil may be electrically configured the same, similarly, or differently based on a desired electrical result of the coil assembly for the system 10.

FIG. 6 is schematic diagram of a linear propulsion system 600 according to one embodiment. The linear propulsion system 600 includes a drive 642, a section of the primary portion 616, and a secondary portion 618 of the linear propulsion system. The drive 642 is a two level, six phase drive, have six phase legs labeled A, B, C, D, E, and F. It is understood that the drive 642 may be three level, or N-level, and embodiments are not limited to 2-level drives. In the depicted embodiment, the primary portion 716 of the linear propulsion system 600 includes twelve coils 654 designated as A*, E, B, F*, C*, D, A, E*, B*, F, C and D*. The letter designates which phase the coil belongs to, and the presence or absence of the * indicates the winding direction. That is, coils are constructed without any current such that the current will circulate clockwise or counterclockwise depending on where the current flows in and out. A pair of coils 654 is associated with each phase (e.g., A and A*). Current flow in coil A is in the opposite direction as current flow of coil A*. The primary portion 616 of the linear propulsion system can be core-less. Alternatively, the coils 654 of the primary portion 616 may be formed about ferromagnetic cores with concentric coils wound around primary teeth. The coils 654 may be also placed on a ferromagnetic flat support 650, forming toothless primary portion 616.

The coils 654 of the primary portion 616 are arranged in a star configuration, where coils for each phase (e.g., A and A*) are in electrical series from a respective phase leg of the drive 642 to a neutral point 658. It is understood that other coil configurations may be utilized other than star configuration.

The secondary portion 618 of the linear propulsion system 600 includes twenty two magnetic poles 656. The magnetic poles 656 may be arranged as shown in FIG. 6 using twenty two permanent magnets, arranged in alternating polarity facing the primary portion 616. In other embodiments, the twenty two magnetic poles 656 may be arranged as part of a Halbach array. The spacing of the permanent magnets or poles 656 (e.g., center-to-center) is referred to as the pole pitch. The spacing of the coils 654 (e.g., center-to-center) is referred to as the coil pitch. The ratio of the magnetic pole pitch to the coil pitch equals 6/11. Permanent magnets of the secondary portion 618 may be mounted on a ferromagnetic flat support 652. The secondary portion 618 may be positioned on one side of primary portion 616, or on both sides of the primary portion 616.

Although FIG. 6 depicts twelve coils and twenty two magnetic poles, the linear propulsion system may be generalized as having 12N coils and 22N magnetic poles, where N is a positive integer.

In view of the above, the technical effects and benefits of embodiments of the linear motor system enable fast, high volume production methods, which can be automated, that result is a significant cost savings relative to winding of wire. Further, the technical effects and benefits of embodiments can include more precise turns that increase the cross sectional area of each coil, which produces more efficient electrical characteristics. Furthermore, technical effects and benefits of embodiments can enable multicar, ropeless elevator system more cost competitive compared to roped elevators.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method of manufacturing a coil assembly, comprising:
acquiring a sheet of a conductive metal;
producing a plurality of coils from the sheet of conductive metal;
layering at least a first coil and a second coil of the plurality of coils with an insulation layer there between to construct the coil assembly,
wherein the first coil is within a first layer of the coil assembly and is oriented in a first spiral direction,
wherein the second coil is within a second layer of the coil assembly and is oriented in a second spiral direction that is opposite the first spiral direction; and
electrically coupling the first and second coils within the coil assembly.

2. (canceled)

3. The method of claim 1, further comprising:
potting the coil assembly.

4. The method of claim 1, wherein the electrically coupling of the first and second coils includes inserting a conductive connection through designated contacts of the first and second coils.

5. (canceled)

6. The method of claim 1, wherein the coil assembly is included in a linear motor system of an elevator system.

7. The method of claim 1, wherein the coil assembly is mounted on a ferromagnetic support.

8. The method of claim 1, wherein the coil assembly is one of a plurality of assemblies, each coil assembly being associated with each phase of a drive signal,
wherein each coil assembly comprises a corresponding plurality of coils which are connected in series enabling an applied current to flow in opposite directions with respect to any adjacent coil assemblies of the plurality of assemblies.

9. The method of claim 1, further comprising:
forming a coating of insulation material on each of the plurality of coils, the forming of the coating of insulation material on of the plurality of coils includes forming the insulation material directly onto each coil.

10. The method of claim 1, further comprising:
extracting the coils from an aluminum sheet; and
performing an anodizing process to create an insulating layer.

11. The method of claim 1, wherein the insulation layer is a sheet of insulating material applied between the first and second coils of the plurality of coils.

12. A coil assembly, comprising:
at least a first coil and a second coil of a plurality of coils, each of the plurality of coils being extracted from a sheet of conductive material,
wherein the first coil is within a first layer of the coil assembly and is oriented in a first spiral direction,
wherein the second coil is within a second layer of the coil assembly and is oriented in a second spiral direction that is opposite the first spiral direction; and a first insulating layer configured between the first and second coils of the plurality of coils.

13. The coil assembly of claim 12, wherein each coil of the plurality of coils includes a metal band with a first thickness, a first width that width, and formed with at least eight turns to produce a structure of each of the plurality of coils.

14. The coil assembly of claim 12, wherein the first and second coils are rounded at each turn during stamping or cutting.

15. The coil assembly of claim 12, wherein the first and second coils are cornered at each turn during stamping or cutting.
